(19) United States
(12) Patent Application Publication
(10) Pub. No.: US 2001/0054178 A1
(43) Pub. Date: Dec. 20, 2001

(54) User history information generation of multimedia data and management method thereof

(75) Inventors: Jin Soo Lee, Seoul (KR); Kyoung Ro Yoon, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 09/803,990

(22) Filed: Mar. 13, 2001

(30) Foreign Application Priority Data
Mar. 14, 2000 (KR) 12793/2000

(51) Int. Cl. H04N 7/16; H04H 9/00

(52) U.S. Cl. 725/9

(57) ABSTRACT

The present invention relates to a method for generating user history information of multimedia data, the present invention generates usage summary information by recording frequency of usage about the feature information of the multimedia data in a feature table, generates a user history list including link information (address) of the feature table in the usage summary information, and provides a user profile information for reflecting user preference by applying those information, therefor efficiently recording the feature information of multimedia data in limited space, and providing a user-oriented multimedia service to the user.

### BACKGROUND OF THE INVENTION

1. Field of the Invention

The present invention relates to an application of multimedia data, in particular to a method for generating user history information of multimedia data and a method for managing the user history information which is capable of providing a user-oriented multimedia service.

2. Description of the Prior Art

As multimedia consumption has been rapidly increased and a movement for providing more user-oriented service has been activated, much user-friendly services reflecting a user preference by making a system to observe a usage pattern of the user.

In the conventional technology, in supplying a user guide, a user adaptive interface is provided by using a use history information on how frequently the user generally checks a multimedia item.

In other words, when the guide is provided as a tree structure, the usage history can shorten a path for finding a user requested part by adjusting a part frequently referenced by the user as higher level.

In addition, the other conventional technology provides a user adaptive interface by setting a function of each button as a user requested function.

In particular, with the advent of a digital broadcasting, additional functions using it has been introduced as very important elements.

Among them, there is a multimedia retrieval and display method which extracts user preference by using the usage history of the user, and performs multimedia retrieval and display by reflecting it.

In addition, there is an intelligent display method which records display operation of a user such as a replay, a fast forward etc. and describes a user preference point by data segments by using it.

For example, it is possible to display a certain segment slowly in search by regarding the certain segment frequently replayed as an important segment.

In addition, in the conventional technology, a user adaptable environment is provided by recording device information such as a user preference channel, and preference volume of each channel etc.

In another conventional technology, in supply of a program guide, a method for providing a program guide focusing on a user preferred program genre to each user is used on the behalf of transmitting huge amount of a program guide as it is.

The preference about the user preferred genre can be extracted by recording viewing data of the user in ordinary times.

In another method of the conventional technology, there is provided a system for automatically selecting a user-preferred program and recording it by using a multimedia viewing history of a user.

In addition, there is a method introducing a smart card in order to provide a user adaptive services not a server-based or a device-based service in the conventional technology. The method using a smart card is capable of providing a consistent user-adaptive service without being influenced by a server or a device by recording user preference information on the smart card.

Most of the above-mentioned efficient functions are performed on the basis of history record about multimedia data usage of the user.

In other words, the preference information can be extracted by recording the multimedia data usage of the user, and recording the pattern or habit as a numerical value.

In order to record the usage pattern of the user as the numerical value, full history from the usage start time point to the present times has to be reflected, however there is a limitation to describe the user history for a certain time period with a certain numerical value.

In addition, sequential history can be used in case of needs, however consecutive recording of sequential usage operation should be stored as a list format.

There is a history method such as a Netscape etc. in the prior art to store the consecutive recording of sequential usage operation as a list format.

The history in the Netscape etc. can store the usage record by describing used multimedia data, namely, address of a document.

However, the history information in accordance with the conventional technology can have to record not only position information of the used multimedia data but also additional feature information such as meta information of the pertinent data etc.

For example, in a case of record using motion picture, not only a position or a title of the relevant motion picture but also various feature information such as a genre, an actor, a director etc. of the motion picture should be recorded together. In that case the user preference information can be extracted by reflecting it.

However, when the all information is recorded on the history list, because there is space waste due to duplicate information, it is difficult to manage the all information in a storage having limited capacity such as the smart card.

In addition, because data volume according to one record is big, the efficiency of data access speed is lowered.

Accordingly, in next generation multimedia application considering feature information such as the meta information besides multimedia data itself as important elements, a data structure for efficiently managing the all information with history, a generation method thereof, and a management method thereof are required.

### SUMMARY OF THE INVENTION

Accordingly, the present invention is directed to a method for generating a user history information of multimedia data and a method for managing the user history information that substantially obviate one or more of the problems due to limitations and disadvantages of the related art.

To solve the above problems, the object of the present invention is to provide a method for generating user history information of multimedia data and a method for managing the user history information, which is capable of efficiently describing feature information of multimedia data used by a user in limited space.

The other object of the present invention is to provide a method for generating user profile information, which is capable of providing a user-oriented multimedia service by adapting the method for generating user history information of multimedia data and the method for generating user history information to user preference information.

In order to achieve the objects of the present invention, the method for generating user history information of multimedia data in accordance with the present invention comprises processes of: generating usage summary information including feature information of the multimedia data and feature table including usage frequency for the feature information; and generating a usage history list including feature code for linking the feature information.

In order to achieve the objects of the present invention, the method for managing user history information of multimedia data in accordance with the present invention comprises processes of: checking whether the feature information corresponding to an event has already been recorded in the usage summary information item when the event to be included in the user history information occurs; recording the relevant feature information in the usage summary information item when the feature information has not been recorded on the usage summary information item; and recording link information about the feature information and information corresponding to the event in a usage history item to be added to the user history list.

In order to achieve the objects of the present invention, the method for generating user profile information on the basis of the method for generating user history information of multimedia data and the method for managing the user history information in accordance with the present invention for reflecting user preference of multimedia data comprises processes of: generating user-designated history information compulsorily or automatically designated by need of a user; generating conditional usage history information for managing a user history satisfying only a certain condition; and generating unconditional usage history information for continually reflecting a user history from the time of generation of the user history.

### BRIEF DESCRIPTION OF THE DRAWINGS

FIG. 1 illustrates a method for generating user history information in accordance with the embodiment of the present invention.

FIG. 2 illustrates a method for generating user history information in accordance with the other embodiment of the present invention.

FIG. 3 is a flow chart illustrating the embodiment of a history item adding process in the method for managing user history information in accordance with the present invention.

FIG. 4 is a flow chart illustrating the embodiment of a history item deleting process in the method for managing user history information in accordance with the present invention.

FIG. 5 illustrates a hierarchical structure of feature information in the method for managing user history information in accordance with the present invention.

FIG. 6 is a block diagram illustrating a method for generating user profile information in accordance with the present invention.

FIG. 7 illustrates a method for generating user history information in accordance with the other embodiment of the present invention.

### DETAILED DESCRIPTION OF THE PREFERRED EMBODIMENT

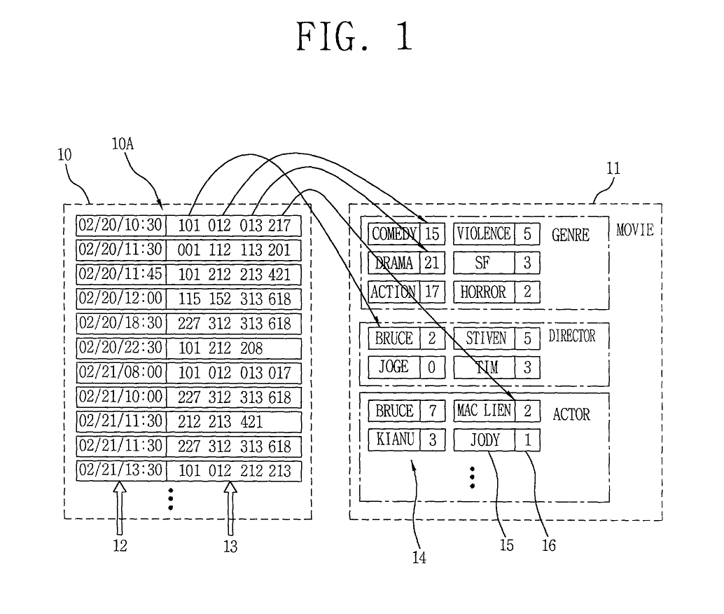

Hereinafter, the embodiments in accordance with the present invention will now be described in detail with reference to accompanying FIG. 1˜7.

In user history information of multimedia data, a conditional history for managing only history satisfying a certain condition such as a certain period or recent N number of event etc. is very important information for constructing user preference.

For example, in order to extract recent pattern information of a user, a history having a certain period condition has to be managed, and a recent preference pattern of the user can be described from the history.

In order to extract the user preference information from the history, feature information of multimedia data used for the preference has to be described (recorded) in the history information.

In other words, besides the multimedia data itself, information describing the content or feature of the multimedia data has to be described (recorded) additionally, because the added information exists massively in each data, it is difficult to record it at each history occurrence.

Accordingly, a method for describing and managing the feature information with a history in accordance with a certain condition is required.

Therefore, the present invention is to provide the method for generating user history information and the method for managing the user history information for updating and maintaining the user history, which constructs the usage summary information by recording the usage frequency of feature information on the multimedia data used by the user in a feature table, and constructs link (address) information corresponding to the feature table of the usage summary information in the usage history list, therefor efficiently recording the feature information of the multimedia data used in the conditional history and adapt it to the user preference information.

In addition, the present invention provides the method for generating user profile information, therefor reflecting the user preference by generating the abovementioned conditional history in the user history information of the multimedia data.

FIG. 1 illustrates the method for generating user history information in accordance with the embodiment of the present invention.

As depicted in FIG. 1, the user history information for managing the conditional user history maintained by a certain period or certain condition is constructed by generating a usage summary information 11 and a usage history list 10.

The usage summary information 11 is constructed with feature information 15 of multimedia data, and feature tables 14 including usage count 16 about each feature information 15.

The usage history list 10 comprises feature codes 13 for linking the feature information corresponding to the usage summary information 11, and history items (record) 10A including usage time information 12 recording usage time and date item of the feature information 15 corresponding to the feature codes 13. The user history information in accordance with the embodiment of the present invention will now be described in detail.

First, the usage history list 10 leaves (includes) usage record whenever the user uses the multimedia data as a history of Netscape.

Herein, the “leaves the usage record” means a usage event of the multimedia data by the user occurs.

Herein, the record included in the usage history list 10 is not maintained eternally but can be deleted after the certain period or by the certain condition.

For example, a certain condition for deleting the pertinent history item 10A by judging deletion from the first history item by comparing the number of the history item 10A of the usage history list 10 with a certain set reference number of history item can be presented.

In the other example, when the usage record of the user is deleted after a certain period, the usage record of the user passed a certain time period can be deleted from the usage history list 10 by the usage time information 12.

Herein, the usage time information 12 is dependent information on the multimedia data used in the each history item 10A, it can be time (date) information when the multimedia data is used or a title of the data or a position (URL) of the data or combination of them.

In the another example, the usage record (information) of the user can be maintained on the basis of the number of the history item (record) 10A included in the usage history list 10, at this time when the number of the history item (record) 10A included in the usage history list 10 is bigger than a certain threshold value as a certain reference value, it is possible to delete from the first recorded history item 10A.

In other words, when the content (history item) recorded on the usage history list 10 is bigger than the certain threshold value as the certain reference value, the first recorded usage content (history item) is deleted.

As described above, not all feature information 15 of the data used for each record is recorded on the each history item (record) 10A included in the usage history 10 which is altered variably, but only the address (or reference) is recorded on the feature code 13 in order to describe where the content corresponding to the feature information 15 of the data is placed in the feature table 14 in the usage summary information 11.

For example, when the multimedia data used by the user includes the feature information 15 having content such as a melodrama as a genre, Bruce as a director, Jody as the leading part, the feature information 15 is not recorded in the usage history list 10, but only the address corresponding to the feature information 15 is recorded on the feature code 13 item of the usage history list 10.

In addition, when the usage record of the feature data is added to the usage history list 10, the address of the feature information 15, namely, the feature code 13 is added (recorded) together, at the same time the usage count of the items of the feature information 15 increase.

On the contrary, when the history item 10A is deleted from the usage history list 10 by the certain condition, the usage count 16 of the items of the each feature information 15 decrease.

Herein, in order to search the feature information 15 recorded on the usage history list 10 for decreasing the usage count 16 of the history items 10A, the usage count 16 of the feature information 15 is decreased by referencing the feature code 13.

By using the above-described usage history information, the conditional usage history can be managed efficiently without duplication for not only simple usage information but also detailed feature information.

In addition, it is possible to perform the user basis service by using the user history information in accordance with the embodiment of the present invention to determine recent usage habit or recent preference of the user.

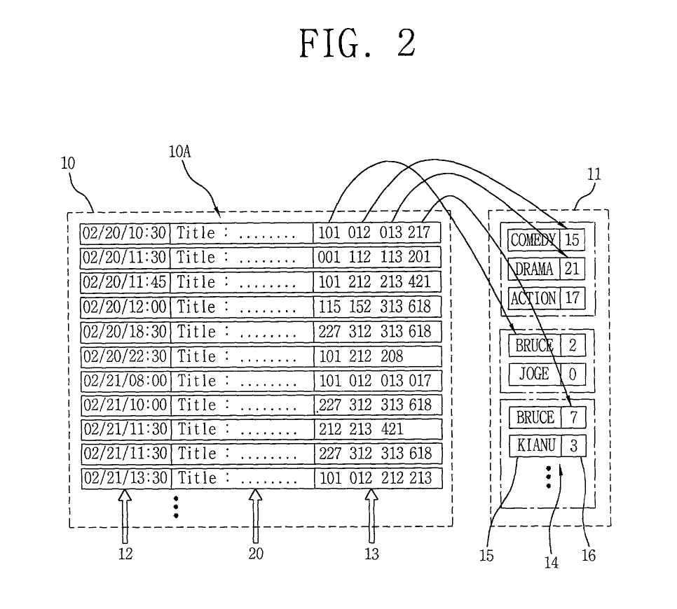

Hereinafter, in the method for generating user history information of FIG. 1, the other embodiment of the present invention which generates data original information more to the usage history list 10 will now be described in detail with reference to accompanying FIG. 2.

FIG. 2 illustrates a method for generating user history information in accordance with the other embodiment of the present invention. In other words, the data original information 20 is generated more to the usage history list 10 in the method for generating user history information of FIG. 1, the same constructions (10, 10A, 11, 12, 13, 14, 15, 16) with FIG. 1 will have same reference numerals, and the duplicated description will now be abridged.

As depicted in FIG. 2, the user history information in accordance with the other embodiment of the present invention generates (constructs) the data original information such as the title of the data more to the usage history list 10, the user history information in accordance with the other embodiment of the present invention will now be described in detail.

First, the data original information 20 such as the title of the multimedia data corresponding to the feature information 15 such as the genre is recorded on the usage history list 10.

In other words, when the feature information 15 such as the genre is managed in the usage history list 10, because it is duplicated in recording and the volume of the data is vast, it is difficult to manage the system. However, in data original information 20 such as the title of the data, it is not duplicated in recording or the volume of the data is small, because the volume of the data is not decreased and approach has to be performed by using the link, it is not efficient in processing time aspect, when it is recorded on the usage summary information 11. Accordingly, the data original information is recorded on the usage history list 10.

Herein, a file of the pertinent multimedia data or a URL of the position of the feature information (description) 15 is included in the data original information 20.

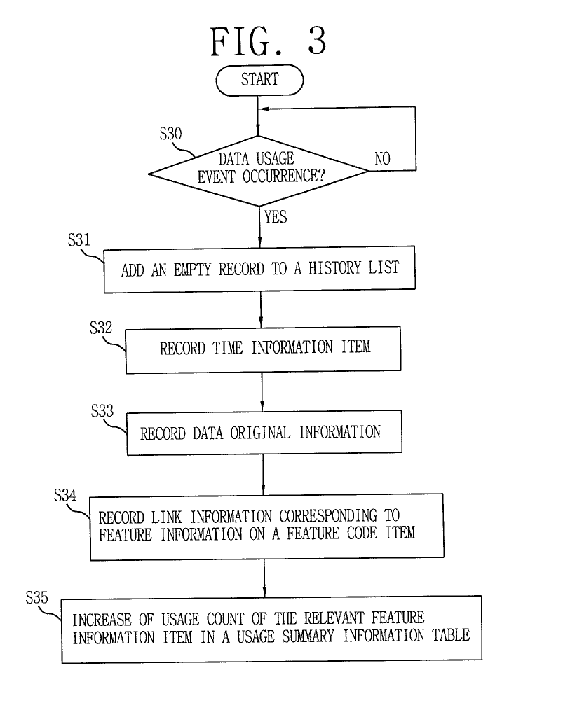

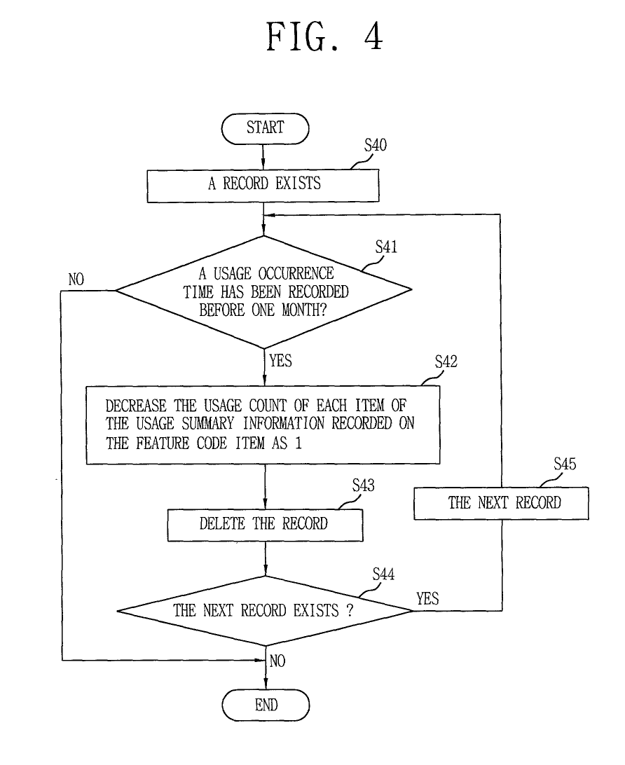

Hereinafter, a method for managing the usage history information of the multimedia data by using the above-described user history information will now be described in detail with reference to accompanying FIG. 3 and 4.

FIG. 3 is a flow chart illustrating the embodiment of a history item adding process in the method for managing user history information in accordance with the present invention. It will now be described in detail.

First, the user judges whether the multimedia data is used or not. In other words, it is judged whether an event to be included in the user history information occurs S30.

When the event to be included in the user history information occurs, one empty history item (record) 10A is added to the usage history list 10 S31.

Time information (usage time and usage date) of the pertinent data is recorded on the usage time information 12 item of the added empty history item (record) 10A S32.

After that, the title of the file of the multimedia data used by the user or the URL of the position of the feature information 15 is recorded on the data original information 20 of the added empty record (record item) 10A S33.

And, the address corresponding to the feature information 15 described in the feature table 14 in the usage summary information 11 is recorded on the feature code 13 of the usage history list 10 S34, and the usage count 16 of the pertinent feature information 15 is increased S35.

In other words, only link information (address) corresponding to the feature information 15 of the usage summary information 11 is coded and is recorded on the feature code 13 item of the usage history list 10.

Herein, the usage count 16 increases whenever the user uses the pertinent feature information 15 S35. For example, the feature information 15 requested by the user is used three times, the usage count 16 increases as many as 3.

FIG. 4 is a flow chart illustrating the embodiment of a history item deleting process in the method for managing user history information in accordance with the present invention.

In other words, it illustrates the process for deleting the history item 10A from the usage history list 10 when the use record of the user is not corresponded to the certain period or certain condition, it will now be described as below.

Herein, when the history item 10A of the usage history list 10 is deleted, it is assumed the history item passed a month is deleted.

First, after setting the certain condition or certain time, it is judged whether the history item (record) 10A of the usage history information exists (occurs) in accordance with the set certain condition or certain period.

When the history item (record) 10A exists (occurs) S40, it is judged whether the history item 10A is recorded before one month S41.

When the history item (record) occurred before the one month S40, the usage count 16 of the each feature information 15 of the corresponding usage summary information 11 decreases as 1 by 1 by using the pertinent address of the feature code 13 of the use history item (record) 10A.

On the contrary, when the history item (record) 10A occurred before the one month S40, in other words, when the history item (record) 10A to be deleted from the usage history list 10A is determined, the history item (record) 10A is deleted from the usage history list 10A S43.

Herein, the deletion of the history item (record) 10A is judged by comparing sequentially from the first of the usage history list 10, namely, the oldest history item (record) 10A with the set period (the certain period).

In other words, the judging process for judging whether the history item 10A is deleted judges the deletion sequentially from the first history item by setting the certain condition as a certain period and checking the period about the each history item.

In addition, the deletion is judged from the superior first history item by comparing the number of the history item 10A of the usage history list 10 with a certain set reference number.

After that, it is judged whether the next usage history item (record) 10A exists (occurs) S44.

When the next usage history record item occurs, the process after the judging process S41 judging whether the usage history record item is recorded before one month are performed repeatedly S45.

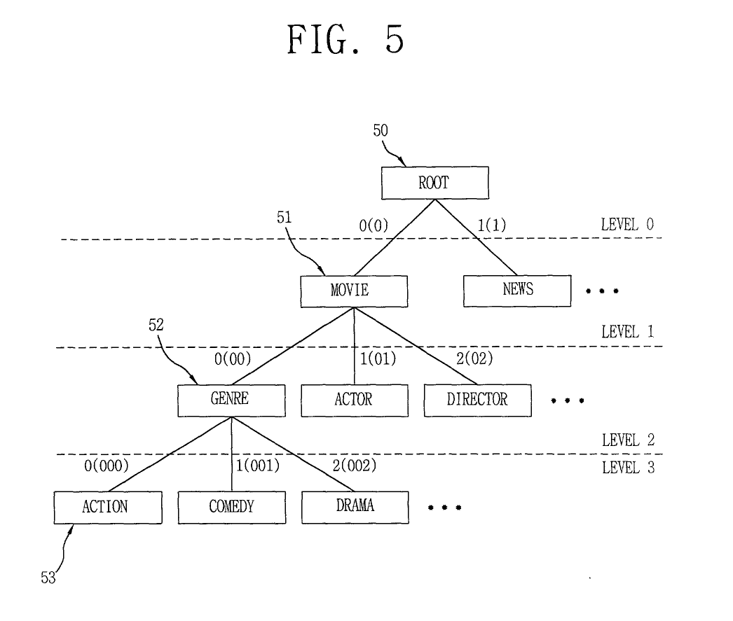

Hereinafter, a method for recording (describing) the address corresponding to the feature information 15 in the usage summary information 11 will now be described in detail with reference of accompanying FIG. 5.

FIG. 5 illustrates a hierarchical structure of feature information in the method for managing user history information in accordance with the present invention.

In other words, in generation of the user history information, the method for designating the address corresponding to the feature information 15 of the usage summary information 11 of the hierarchical structure of the feature information 15 and the feature code 13 will be described, it will now be described in detail as below.

First, the content of the usage summary information 11 can be described as a tree structure when it is described logically.

Herein, a number can be provided to the subordinate nodes of each node downwardly from a root 50 to its leaf.

In addition, when the number is provided to the subordinate nodes centering around the all nodes excluding the leaf, an address for describing the certain leaf can be designated as a consecutive node number connected a path from the root 50 to the leaf.

For example, the address of the leaf corresponding to an action node 53 is ‘000’. In other words, a number within ( ) in the FIG. 5 is the address of the each node provided as the above-mentioned method.

Herein, the hierarchical table structure used in the usage summary information 11 is constructed with detailed items in the comprehensive item corresponding to the feature information, it is not limited by the embodiments of the present invention, but rather it can be used variously in accordance with each user.

Meanwhile, when the usage count 16 of the leaf increase or decrease, the superior structure connected to the leaf also can automatically increase or decrease the usage count 16.

In other words, the usage count 122 of the action (the lowest level) of the leaf No.53 increases or decreases in accordance with the usage event occurrence of the user through the process of FIG. 3, the usage count 16 of the genre 52, and movie 51 as the superior node (superior level) of the pertinent node increases or decreases.

Herein, the increase of the automatic usage count 16 of the superior node can be different according to a required structure.

For example, such as the genre node 52, all nodes placed on a level 2 in the hierarchical table (tree) can not have the usage count 16, in this case, the all nodes placed on the level 2 are used only for the hierarchical structure of the node, and are not used for the preference information itself.

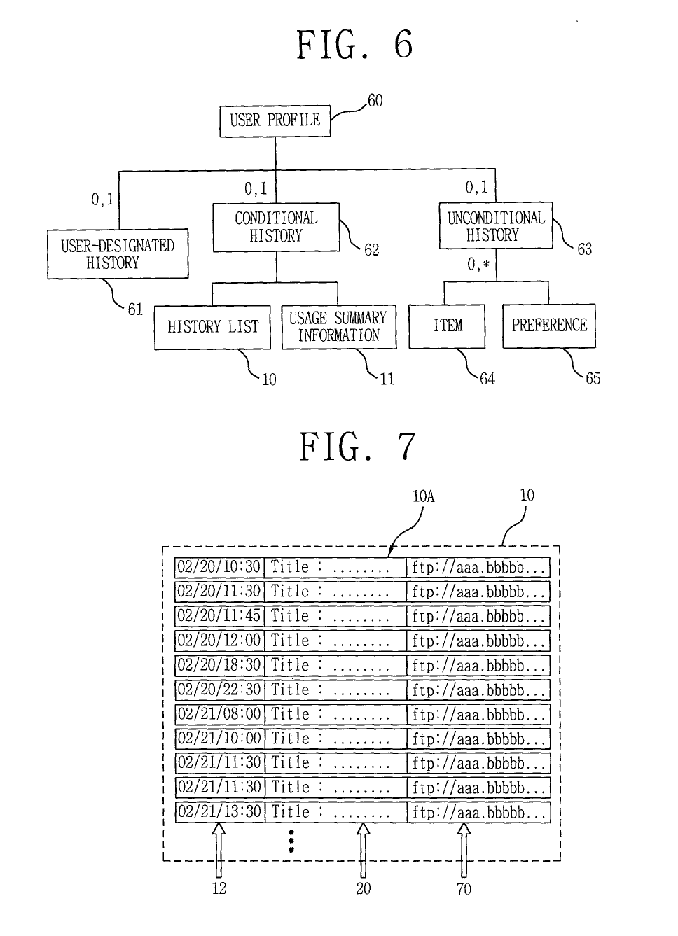

Hereinafter, the method for generating user profile information for reflecting the user preference by using the user history information in accordance with the embodiments of the present invention will now be described in detail with reference to accompanying FIG. 6.

FIG. 6 is a block diagram illustrating a method for generating user profile information in accordance with the present invention.

As depicted in FIG. 6, the user profile information 60 comprises unconditional history information 63, conditional user history information 62, and user-designated history information 61. It will now be described in detail.

First, the unconditional history information 63 is the part for recording the user preference item 64 by continually reflecting the usage record of the user from the history occurrence time point by the user, the feature information 15 and the preference information 65 corresponding to the feature information 15 as the numerical value are recorded in the preference item 64.

Herein, the preference 65 about the each preference item 64 can be described as the numerical value, the numerical value of the preference 65 is a stored value after being updated continually whenever the data usage of the user occurs.

As described above, the conditional user history information 62 manages only the history satisfying the certain condition, the conditional user history information is divided into the feature information 15 of the pertinent information, the usage summary information 11 including the user frequency about the relevant feature information, and the user history list 10 including the feature code 13 for reading (linking) the feature information 15.

The user-designated history information 61 is the history compulsorily designated by the user in case of needs or the history automatically designated by the system because of the need possibility of the user, it means the data which can be deleted by a certain order of the user.

For example, the user can compulsorily designate the multimedia data such as the position of the interrupted multimedia data, interruption time of the multimedia data, service position of the multimedia data etc. in order to watch later the multimedia data which is interrupted during the audition, or the system can store information needed for the re-service about the interrupted multimedia data by automatically designating it.

Hereinafter, in order to update or extract the user preference information by using the user history information, the relevant feature information is called by using the each link information of the data recorded on the usage history list 10, the method for extracting or updating the pertinent preference item values by using the link information will now be described in detail with reference to accompanying FIG. 7.

FIG. 7 illustrates the method for generating user history information in accordance with the other embodiment of the present invention.

In other words, in the method for generating user history information of FIG. 1 and 2, FIG. 7 generates link information 70 more to the usage history list 10, constructions same with the constructions of FIG. 1 and 2 are described with same reference numerals, and the duplicated descriptions will now be abridged.

As depicted in FIG. 7, the user history information in accordance with the other embodiment of the present invention has the construction adding the link information 70 for receiving the relevant feature information to the usage history list 10, it will now be described in detail as below.

Herein, only the user usage history list 10 is recorded on the conditional user history information 62, and is managed.

Only the multimedia used time information 12 and the link information 70 about the used multimedia data are recorded on the usage history list 10.

In addition, the data original information 20 such as the title of the relevant data can be included in the usage history list 10.

The URL etc. can be used for the link information 70 of the data in order to connect the feature information 15 of the used data.

Although the data feature information is not recorded on the used history information, the relevant information can be called by using the link information 70.

In other words, when the system updates or extracts the user preference information by using the user history information, the relevant feature information 15 can be called by using the each link information 70 of the data included in the usage history list 10.

In addition, the relevant preference item values can be updated or extracted by using the link information 70.

Accordingly, the user history information in accordance with the other embodiment of the present invention can have less data volume than the embodiment of the present invention, and needs to manage only the usage history list 10.

As described above, in providing of the user-oriented service using the user history, the present invention is capable of efficiently extracting the user preference information by effectively managing the history information in the limited space.

In addition, the present invention can perform the management of the user preference per period by extracting the user preference information by the certain period and certain condition without being limited by the conventional method of extracting collective user preference information.

In addition, the present invention can reflect the feature information of various and huge multimedia data to the user history. Accordingly, the present invention can provide a user history management solution applicable to the next generation multimedia data environments, which meta information become more important and a standardization works about it are expected to be progressed.

In addition, the present invention can efficiently control lots of data in the user history management method such as the smart card which is movable and is in small space.

What is claimed is:

1. A method for generating user history information of multimedia data, comprising
generating usage summary information including feature information of the multimedia data; and
generating a usage history list including a feature code for linking the feature information.

2. The method for generating user history information of multimedia data according to claim 1, wherein the usage summary information comprises the feature information, and a feature table including a usage count for each feature information.

3. The method for generating user history information of multimedia data according to claim 1, wherein the usage history list further comprises information dependent on the multimedia data used in each history item.

4. The method for generating user history information of multimedia data according to claim 2, wherein the dependent information includes time (date) information, title of data or position of data (URL) or combination of them.

5. The method for generating user history information of multimedia data according to claim 1, wherein the feature information has a hierarchical table structure.

6. The method for generating user history information of multimedia data according to claim 5, wherein the hierarchical table is constructed with a general item corresponding to the feature information and extended to detailed items.

7. The method for generating user history information of multimedia data according to claim 1, wherein the usage history list can be constructed with only a link information that the feature information is positioned for providing the data corresponding to the link information including the feature information.

8. A method for managing user history information of multimedia data, comprising:
checking, when an event to be included in the user history information occurs, whether feature information corresponding to an event is information that a usage summary information item has already been recorded;
recording the corresponding feature information on the usage summary information item when the usage summary information has not been recorded and
recording link information on the feature information and information corresponding to the event on a history item to be added to the usage history list.

9. The method for managing user history information of multimedia data according to claim 8, further comprising a process of increasing an usage count of the feature information whenever the feature information is used.

10. The method for managing user history information of multimedia data according to claim 8, wherein the feature information has a hierarchical structure.

11. The method for managing user history information of multimedia data according to claim 8, wherein the link information is described on a feature code item in the usage history item.

12. The method for managing user history information according to claim 8, wherein the information corresponding to the event includes usage time information, and original information of the usage data.

13. The method for managing user history information of multimedia data according to claim 8, wherein further comprising the steps of:
judging whether deleting the history item in accordance with a predetermined condition;
decreasing the usage count of the feature information corresponding to the link information recorded on the history item; and
deleting the history item in the usage history list that the link information is recorded.

14. The method for managing user history information of multimedia data according to claim 13, wherein the process for judging whether deleting the history item comprises the process of setting the certain condition as a certain time period, checking the time period of the each history item, and sequentially judging whether deleting each history item from the first.

15. The method for managing user history information of multimedia data according to claim 13, wherein the process for judging whether deleting the history item comprises the process of judging whether deleting the history item from the first, by comparing the history item with a predetermined reference number of history item.

16. The method for managing user history information of multimedia data according to claim 13, wherein the process for judging whether deleting the history item judges whether deleting the history item from the first item by Considering the certain condition and the number of the history item.

17. The method for managing user history information multimedia data according to claim 13, wherein as the usage count for the lowest level of feature information is increased or decreased, the usage count for higher level of feature information is automatically increased or decreased.

18. A method for generating user profile information on the basis of a method for generating user history information of multimedia data and a method for managing the user history information for reflecting user preference of multimedia data, comprising:
generating user-designated history information compulsorily or automatically designated by a user;
generating conditional usage history information for managing a history satisfying a certain condition; and
generating unconditional usage history information for continually reflecting the user history from the time that the user history occurs.

19. The method for generating user profile information according to claim 18, wherein the user-designated history information is constructed with combination of interruption position of the data interrupted during watching, interruption time, and the position of data.

20. The method for generating user profile information according to claim 18, wherein the process for generating the conditional user history information comprises the steps of:
generating usage summary information including frequency of usage about the feature information of the relevant information; and
generating a usage history list including a feature code for reading the feature information in the usage summary information.

21. The method for generating user profile information according to claim 18, wherein the process for generating the unconditional usage history information comprises the steps of:
generating preference information including the feature information and preference corresponding to the feature information as a numeral value.
